(19) United States
(12) Patent Application Publication
(10) Pub. No.: US 2005/0008147 A1
(43) Pub. Date: Jan. 13, 2005

(54) Two-purpose wireless hand-free earphone set for use in driving

(76) Inventor: Tung-Hsun Lee, San Chung City (TW)

Correspondence Address: RABIN & BERDO, P.C.;Suite 600, 1101 14th Street, N.W., Washington, DC, 20005, US

(21) Appl. No.: 10/615,778

(22) Filed: Jul. 10, 2003

(51) Int. Cl. H04M 1/00; H04M 9/00

(52) U.S. Cl. 379/431

(57) ABSTRACT

A two-purpose wireless hand-free earphone set for use in driving includes a transceiver adapted for detachably connecting to a mobile phone, a hand-free earphone adapted for wearing on one ear to receive and send voice-frequency signals from and to said transceiver, and a speaker seat adapted for mounting at a predetermined position in a car to removably hold the hand-free earphone thereto. When the hand-free earphone is positioned on the speaker seat, the voice-frequency signals are switched to and sent out via the speaker seat. With the speaker seat, a user in driving is allowed to talk freely without the need of always wearing the hand-free earphone on one ear, so that any discomfort of the ear caused by wearing the hand-free earphone for a prolonged time is avoided.

### FIELD OF THE INVENTION

The present invention relates to a two-purpose wireless hand-free earphone set for use in driving, and more particularly to a two-purpose wireless hand-free earphone set including a hand-free earphone that may be selectively positioned on a speaker seat for a user in driving to receive and send out voice-frequency signals via the speaker seat without the need of wearing the earphone on one ear for a prolonged time.

### BACKGROUND OF THE INVENTION

The currently commercially available free-hand receivers for mobile phones may be divided into two types, namely, portable and fixed types. The portable hand-free receivers are normally in the form of an earphone and have different transmission manners to be further divided into wired and wireless types.

The wired hand-free earphone is connected to the mobile phone via an electric wire for sending voices to a user's ear. The wired hand-free earphone has the advantages of being conveniently portable for use at any time and at any place and having lower selling price, but tends to cause discomfort to the ear when the earphone is worn for a prolonged time. A wired hand-free earphone having inferior quality may even impair the user's hearing. Moreover, the wire connecting the earphone to the mobile phone also restricts the user from moving freely. It is possible the wire is broken due to undesired moving of the user's body and requires replacement. On the other hand, the wireless hand-free earphone transmits voice to the user's ear by means of radio transmission and has the advantage of being conveniently portable for use without restricting the user's movement. However, the wireless hand-free earphone is not suitable for wearing for a prolonged time, either.

The fixed type hand-free receiver usually takes advantage of an amplifying circuit of a car stereo or includes an amplifying circuit to achieve the purpose of using the mobile phone without the need of holding it with one hand. The fixed type hand-free receiver does not include an earphone to be worn on the user's ear and is therefore harmless to the user's ear and hearing. Another advantage of the fixed type hand-free receiver is it provides better audio quality. However, the fixed type hand-free receiver could not be used outside a car, and requires different mounting seats and signal lines for mobile phones of different brands.

It is therefore tried by the inventor to develop a two-purpose wireless hand-free earphone set to overcome the drawbacks existed in the conventional hand-free receivers for mobile phones, so that a user in driving may select to position a free-hand earphone on a speaker seat to freely listen and talk over a mobile phone via the speaker seat that amplifies and send out voices.

### SUMMARY OF THE INVENTION

A primary object of the present invention is to provide a two-purpose wireless hand-free earphone set that allows a user in driving to freely listen and talk over a mobile phone without the need of always wearing a hand-free earphone.

To achieve the above and other objects, the two-purpose wireless hand-free earphone set of the present invention mainly includes a transceiver adapted for detachably connecting to a mobile phone, a hand-free earphone adapted for wearing on one ear to receive and send voice-frequency signals from and to said transceiver, and a speaker seat adapted for mounting at a predetermined position in a car to removably hold the hand-free earphone thereto. When the hand-free earphone is positioned on the speaker seat, the voice-frequency signals are switched to and sent out via the speaker seat. With the speaker seat, a user in driving is allowed to talk freely without the need of always wearing the hand-free earphone on one ear, so that any discomfort of the ear caused by wearing the hand-free earphone for a prolonged time is avoided.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a two-purpose wireless hand-free earphone set for use in driving according to an embodiment of the present invention;

FIG. 2 is a block diagram showing an internal circuitry of a hand-free earphone included in the present invention;

FIG. 3 is a block diagram showing an internal circuitry of a speaker seat included in the present invention;

FIG. 4 shows the hand-free earphone positioned in the speaker seat of the present invention;

FIG. 5 shows a first manner of using the present invention; and

FIG. 6 shows a second manner of using the present invention.

### DETAILED DESCRIPTION OF THE PREFERRED EMBODIMENTS

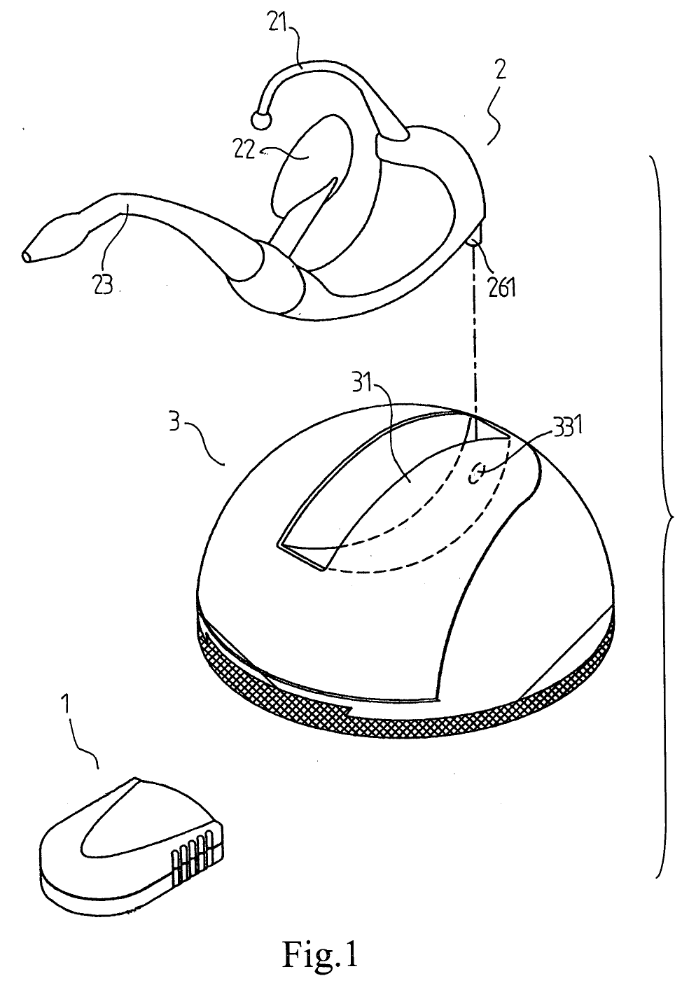

Please refer to FIG. 1 that is an exploded perspective view of a two-purpose wireless hand-free earphone set for use in driving according to an embodiment of the present invention. As shown, the earphone set mainly includes a transceiver 1, a hand-free earphone 2, and a speaker seat 3.

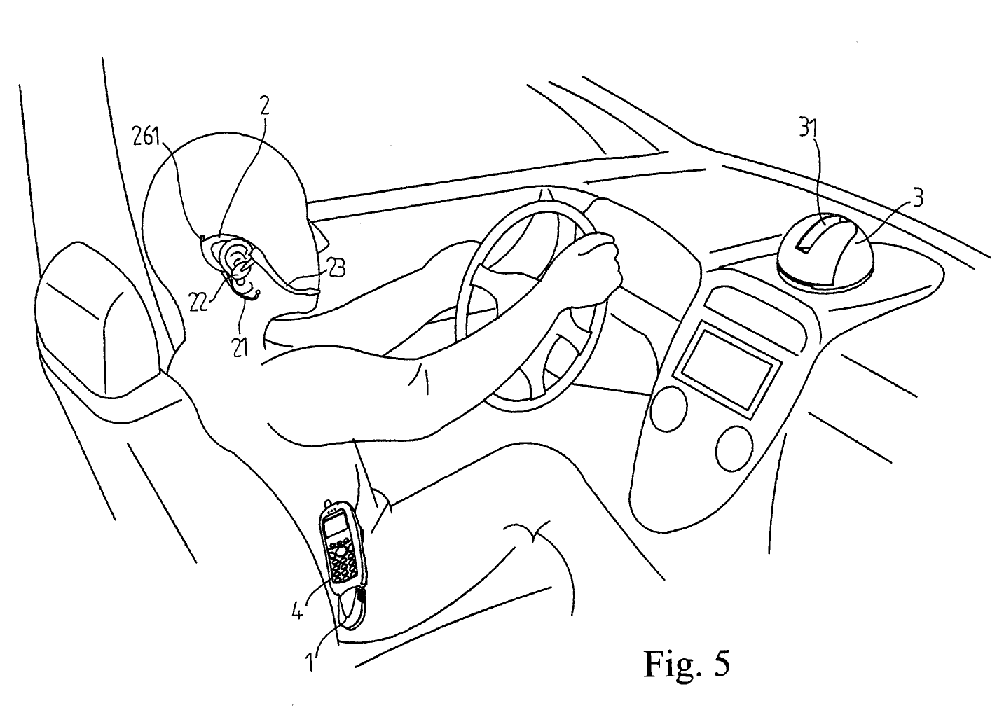

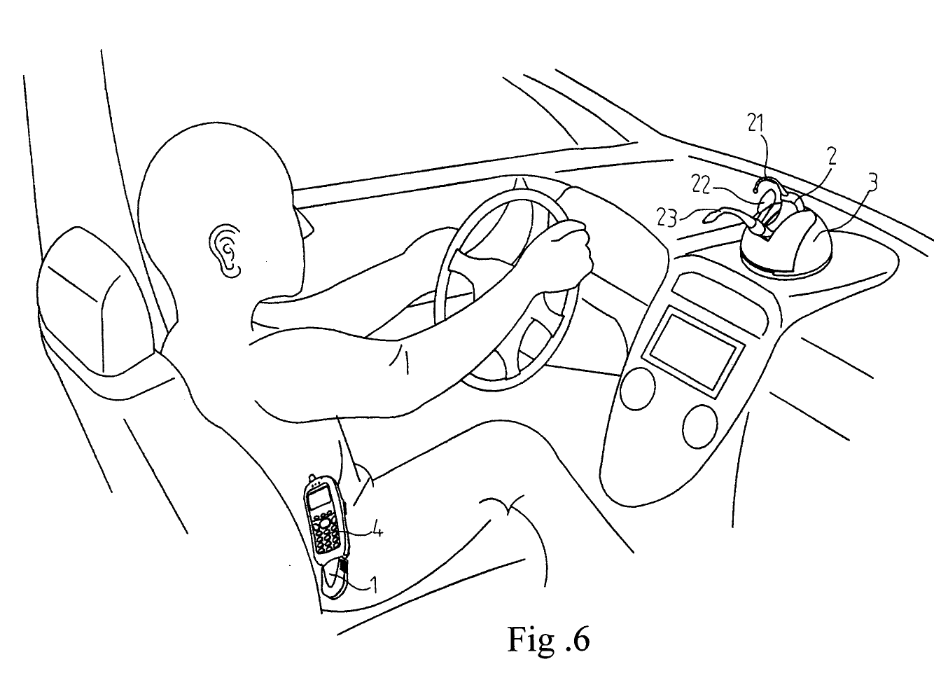

The transceiver 1 is internally provided with a general circuitry for processing, controlling, receiving, and transmitting voice-frequency signals, and externally provided at one side with a connecting terminal (not shown) for plugging the transceiver 1 into a mobile phone 4 (see FIGS. 5 and 6). The transceiver 1 plugged into the mobile phone 4 is adapted to send an incoming call over the mobile phone 4 to the hand-free earphone 2, and receive a user's voice from the hand-free earphone 2.

The hand-free earphone 2 generally includes an ear hook 21, an earplug 22, and a mouthpiece support 23, and is configured for wearing on the user's one ear.

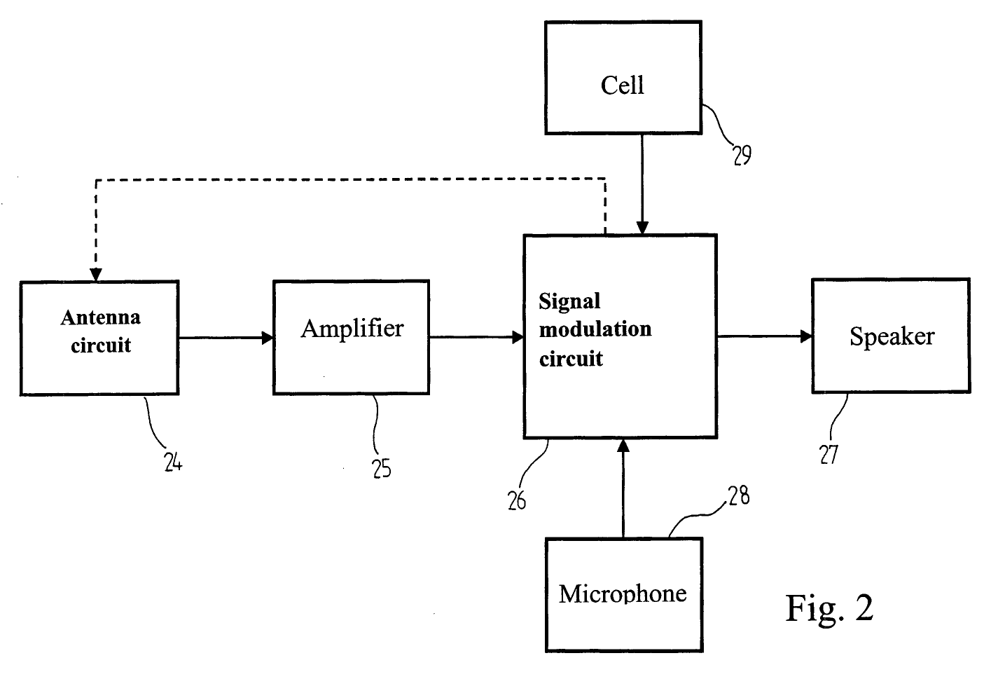

FIG. 2 is a block diagram showing an internal circuitry for the hand-free earphone 2. As shown, the hand-free earphone 2 is internally provided with an antenna circuit 24, an amplifier 25, a signal modulation circuit 26, a speaker 27, a microphone 28, and a small-scale cell 29. The antenna circuit 24 is provided to bi-directionally receive a bi-directional resonant frequency generated by a caller's voice over the mobile phone received by the transceiver 1. The amplifier 25 is electrically connected to the antenna circuit 24 for amplifying signals received by the antenna circuit 24. The signal modulation circuit 26 is electrically connected to the amplifier 25 for identifying and modulating signals output from the amplifier 25. It is to be noted the signal modulation circuit 26 includes a male terminal 261 projected from a predetermined position on the hand-free earphone 2. The speaker 27 is electrically connected to the signal modulation circuit 26 for sending out audio signals.

The microphone 28 is electrically connected to the signal modulation circuit 26 and is mounted at a front end of the mouthpiece support 23 for receiving audio signals of the user's voices. The audio signals are then converted and sent to the signal modulation circuit 26 for frequency modulation before being sent to the transceiver 1 via the antenna circuit 24. The small-scale cell 29 supplies the power required by the whole hand-free earphone 2 to operate.

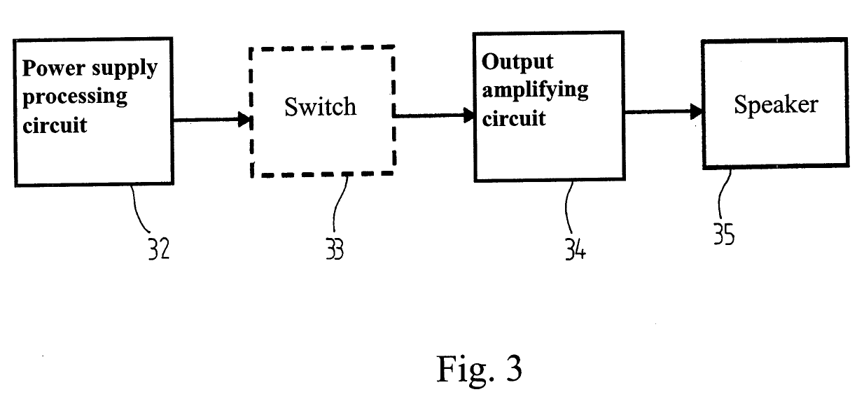

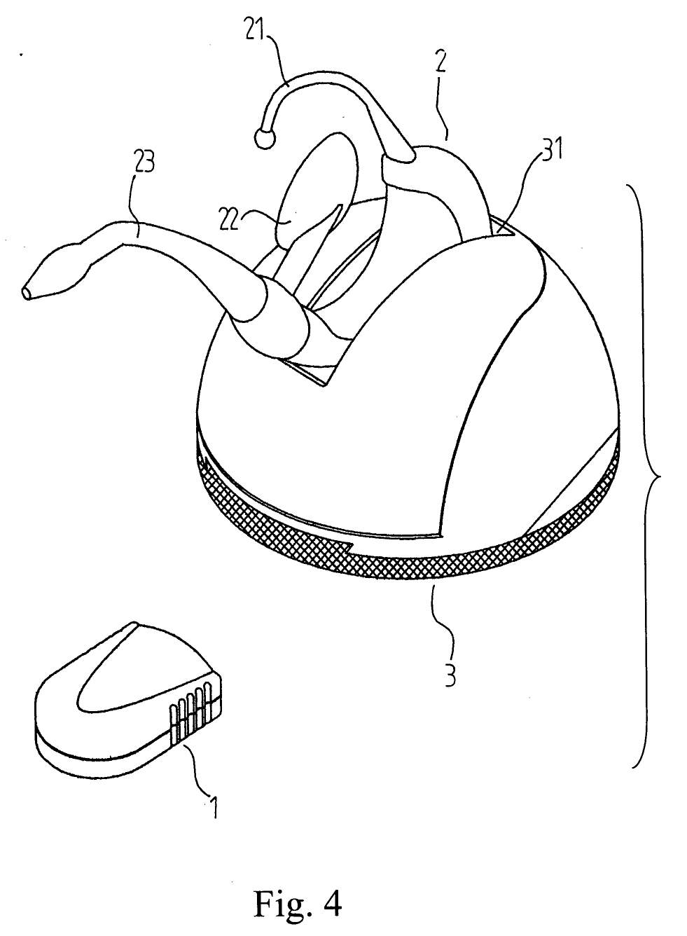

The present invention is characterized in the provision of the speaker seat 3. The speaker seat 3 is a substantially semispherical member for mounting on, for example, a dashboard in a car. The speaker seat 3 is provided near a top with a recess 31 adapted to receive the hand-free earphone 2 therein. FIG. 3 is a block diagram showing an internal circuitry for the speaker seat 3. As shown, the speaker seat 3 is internally provided with a power supply processing circuit 32, a switch 33, an output amplifying circuit 34, and a speaker 35. The power supply processing circuit 32 includes wires for plugging into a power supply jack, such as a cigarette lighter, provided in the car to obtain operating power for the speaker seat 3. The switch 33 includes a female terminal hole 331 provided in the recess 31. Please refer to FIG. 4. When the hand-free earphone 2 is positioned in the recess 31 on the speaker seat 3, the male terminal 261 is adapted to plug into the female terminal hole 331 in the recess 31 to actuate the switch 33 inside the speaker seat 3, so that audio signals of the user's voices modulated by the signal modulation circuit 26 inside the earphone 2 are switched to the output amplifying circuit 34 inside the speaker seat 3 to be finally sent out via the speaker 35 that is electrically connected to the output amplifying circuit 34.

Please refer to FIGS. 5 and 6 that shows two different manners of using the wireless hand-free earphone set of the present invention. As can be seen from FIG. 5, the user wears the wireless hand-free earphone 2 on one ear while driving. When the hand-free earphone 2 has been worn on the ear for a prolonged time to cause discomfort to the ear, the user may select to take off the hand-free earphone 2 and position it in the recess 31 on the speaker seat 3, as shown in FIG. 6. When the hand-free earphone 2 has been properly positioned in the recess 31 with the male terminal 261 projected from the hand-free earphone 2 aligned with and plugged into the female terminal hole 331 in the recess 31 to enable switching of signals, the caller's voice is sent out via the speaker seat 3. Itis to be noted the microphone 28 internally provided at the front end of the mouthpiece support 23 of the hand-free earphone 2 is still workable for receiving the audio signals of the user's voice. It means the user needs only to talk while facing toward the hand-free earphone 2 positioned in the speaker seat 3. In brief, the present invention is characterized in that it permits the user in driving to position the hand-free earphone 2 in the speaker seat 3, so that the audio signals that are otherwise sent out via the earplug 22 is switched to the speaker seat 3, at where the audio signals are amplified and output, and the user may still freely talk over the mobile phone without wearing the hand-free earphone 2 on the ear. Of course, the user may select to remove the hand-free earphone 2 from the speaker seat 3 and wear the earphone 2 on one ear when he or she is not in the car. In the latter case, the audio signals of an incoming call over the mobile phone are directly sent out via the earplug 22 of the hand-free earphone 2.

The present invention has been described with a preferred embodiment thereof and it is understood that many changes and modifications in the described embodiment can be carried out without departing from the scope and the spirit of the invention as defined by the appended claims.

1. A two-purpose wireless hand-free earphone set for use in driving, comprising a transceiver adapted for detachably connecting to a mobile phone, a hand-free earphone adapted for wearing on one ear to receive and send voice-frequency signals from and to said transceiver, and a speaker seat adapted for mounting at a predetermined position in a car to removably hold said hand-free earphone thereto; said voice-frequency signals being switched to and sent out via said speaker seat when said hand-free earphone is positioned on and held to said speaker seat; whereby a user in driving is allowed to listen and talk freely without the need of always wearing said hand-free earphone on one ear and any discomfort of the ear caused by wearing said hand-free earphone for a prolonged time is avoided.

2. The two-purpose wireless hand-free earphone set for use in driving as claimed in claim 1, wherein said hand-free earphone includes a male terminal outward projected from a predetermined position on said hand-free earphone and electrically connected to a circuitry internally provided in said hand-free earphone, and said speaker seat being externally provided at a predetermined position with a recess, in which a female terminal hole is provided for said male terminal of said hand-free earphone to plug thereinto when said earphone is positioned in said recess on said speaker seat.

3. The two-purpose wireless hand-free earphone set for use in driving as claimed in claim 1, wherein said speaker seat is internally provided with a switch for switching said voice-frequency signals from said hand-free earphone to said speaker seat for sending out said voice-frequency signal via said speaker seat when said hand-free earphone is positioned on and held to said speaker seat.

4. The two-purpose wireless hand-free earphone set for use in driving as claimed in claim 2, wherein said speaker seat is internally provided with a switch for switching said voice-frequency signals from said hand-free earphone to said speaker seat for sending out said voice-frequency signal via said speaker seat when said hand-free earphone is positioned in said recess on said speaker seat with said male terminal plugged into said female terminal hole that is electrically connected to said switch.
